(19) United States
(12) Patent Application Publication
(10) Pub. No.: US 2023/0296104 A1
(43) Pub. Date: Sep. 21, 2023

(54) BLADE FOR ROOM FANS AND RELATED FAN

(71) Applicant: MOTORDESIGN MODENA S.r.l., Modena (IT)

(72) Inventor: William GUALTIERI, Modena (IT)

(73) Assignee: MOTORDESIGN MODENA S.r.l., Modena (IT)

(21) Appl. No.: 18/040,842

(22) PCT Filed: Aug. 24, 2021
(86) PCT No.: PCT/IB2021/057745

§ 371 Date: Feb. 7, 2023

(30) Foreign Application Priority Data
Aug. 26, 2020 (IT) 102020000020488

(51) Int. Cl. F04D 25/08; F04D 29/38

(52) U.S. Cl. CPC F04D 25/088; F04D 29/386; F05D 2240/301; F05D 2240/307

(57) ABSTRACT

A blade for room fans comprising an elongated body extending longitudinally along a longitudinal direction of development and provided with a first end mounted, in use, on a central body movable in rotation around an axis of rotation orthogonal to the direction of development for the movement of at least one air flow intended for the airing/ventilation of rooms, and a second end opposite said first end, the elongated body rotating arranged on a plane of rotation orthogonal to the axis of rotation; wherein the elongated body is provided with a cross section the inclination of which with respect to the plane of rotation and/or the conformation of which varies along the direction of development.

### TECHNICAL FIELD

The present invention relates to a blade for room fans and a related fan.

### BACKGROUND ART

A wide variety of blades are known to be used to make different types of fans capable of producing a current of air intended to air and/or ventilate rooms.

The blades of known type are provided with an elongated body which extends longitudinally along a preferred direction of development.

In this way, one or more blades are associated in a radial pattern with a central body and are placed in rotation by the latter around an axis of rotation.

Such rotation allows generating an air flow along a direction of movement substantially perpendicular to the rotational plane on which the blades themselves rotate.

However, this type of fans is susceptible to improvements related to the characteristics of the air flow generated by the blades.

In fact, the elongated bodies of the blades of known type are provided with a cross section which remains constant along the entire length of the same elongated body, that is, along the direction of development.

This makes the flow rate of the air flow generated by the blades irregular along the direction of development of the blades, making their use inconvenient.

In particular, the flow rate of the air flow moved by this type of blades is maximum along a portion of extremely limited length of the elongated body, thus decreasing significantly along the other portions of the same body.

### DESCRIPTION OF THE INVENTION

The main aim of the present invention is to devise a blade for room fans which allows improving and optimizing the characteristics of the air flow moved by the blade with respect to those of known type.

A further object of the present invention is to devise a blade for room fans which allows the air flow generated by the blades to be substantially constant along the direction of development of the blades themselves.

An additional object of the present invention is to devise a blade for room fans which allows increasing the flow rate of the total air flow generated by the blade, the total dimensions of the blades of known type being equal.

An additional object of the present invention is to devise a blade for room fans which allows increasing the distance covered by the air flow moved, the total dimensions of the blades of known type being equal.

A further object of the present invention is to devise a blade for room fans which allows the blade itself to be mounted quickly, easily and safely.

Another object of the present invention is to devise a blade for room fans, which allows the aforementioned drawbacks of the prior art to be overcome, within the scope of a simple, rational, easy and effective to use as well as affordable solution.

The aforementioned objects are achieved by the present blade for room fans having the characteristics of claim 1.

The aforementioned objects are achieved by the present fan having the characteristics of claim 9.

### BRIEF DESCRIPTION OF THE DRAWINGS

Other characteristics and advantages of the present invention will become more apparent from the description of a preferred, but not exclusive, embodiment of a blade for room fans, illustrated by way of an indicative, yet non-limiting example, in the accompanying tables of drawings wherein:

FIG. 1 is an axonometric view of a fan according to the invention;

FIG. 2 is an axonometric view of a blade according to the invention;

FIGS. 3-7 are cross-sectional views of a blade according to the invention;

FIG. 8 is a detailed view of some elements of the fan according to the invention.

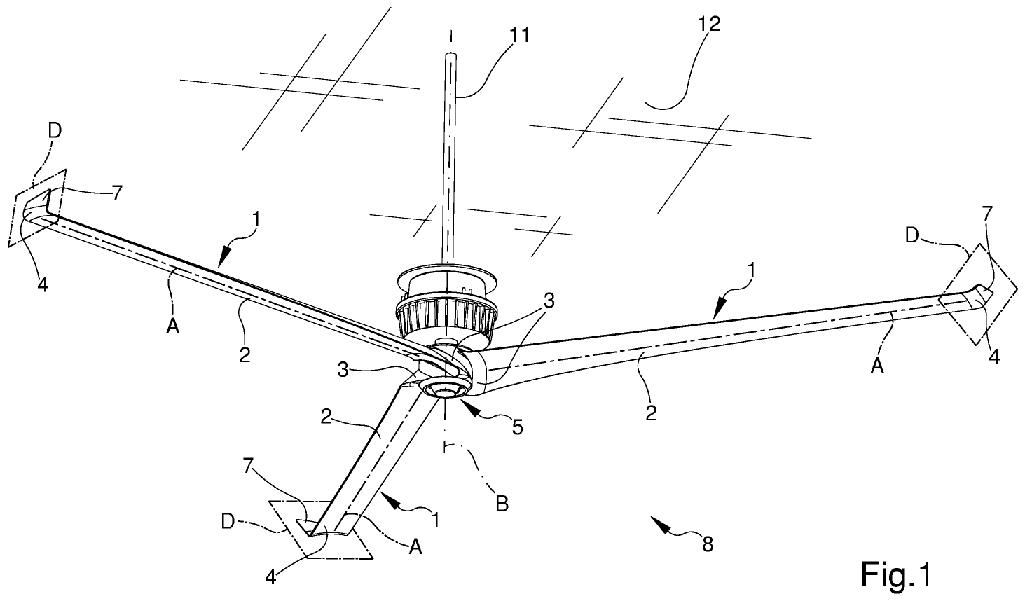

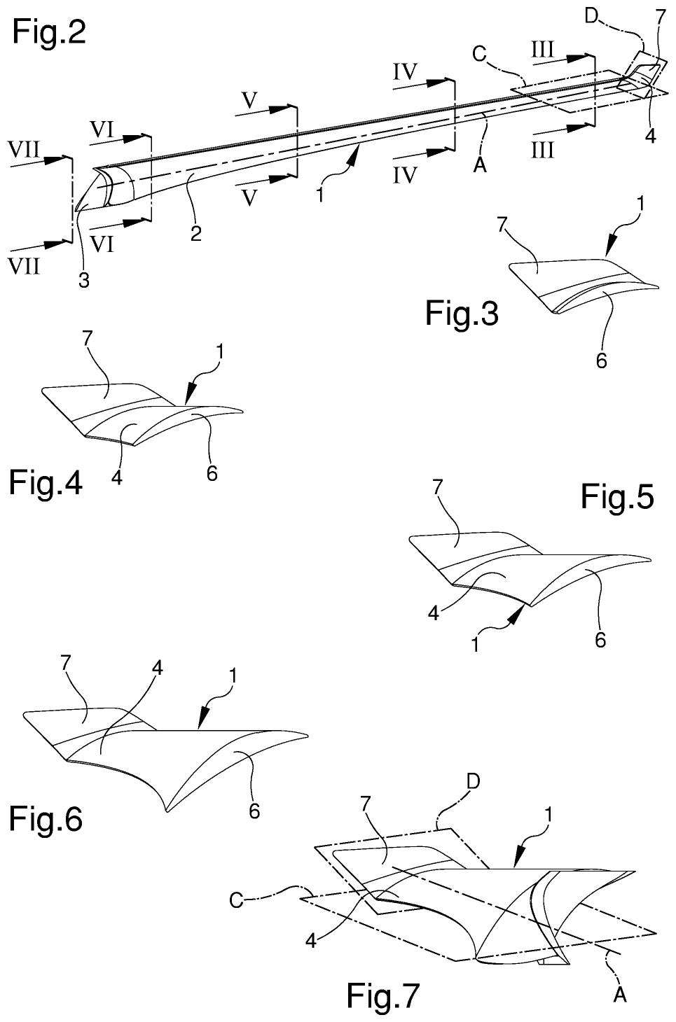

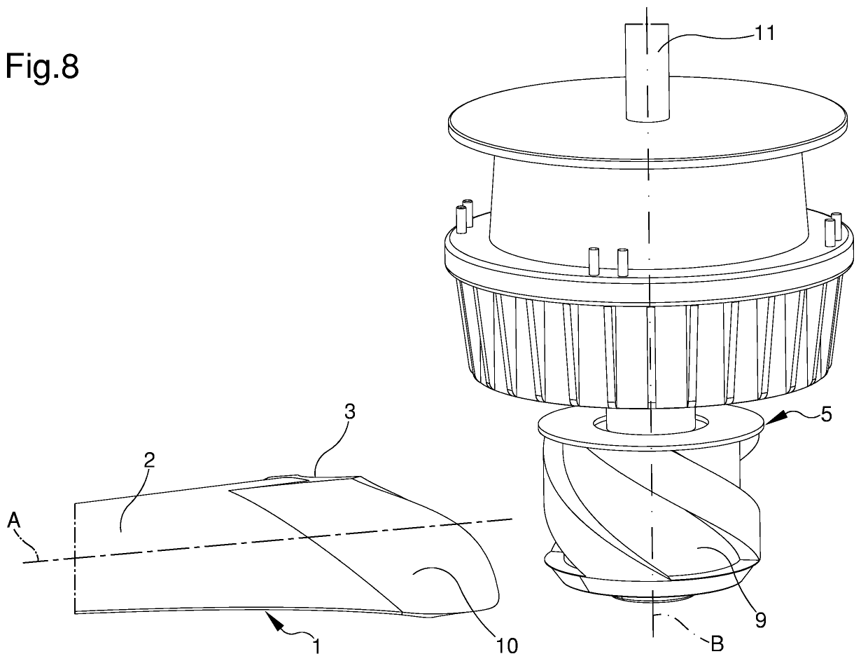

### EMBODIMENTS OF THE INVENTION

With particular reference to these figures, reference numeral 1 globally indicates a blade for fans.

The blade 1 for room fans comprises an elongated body 2 extending longitudinally along a longitudinal direction of development A and provided with a first end 3 mounted, in use, on a central body 5 movable in rotation around an axis of rotation B orthogonal to the direction of development A for the movement of at least one air flow intended for the airing/ventilation of rooms, and a second end 4 opposite the first end 3.

The elongated body 2 rotates arranged on a plane of rotation C orthogonal to the axis of rotation B.

Advantageously, the blade 1 is adapted to move the air flow substantially along the axis of rotation B.

In particular, the elongated body 2 is provided with a cross section 6 the inclination of which with respect to the plane of rotation C and/or the conformation of which varies along the direction of development A.

Preferably, the inclination with respect to the plane of rotation C and/or the conformation of the elongated body 2 varies continuously along the direction of development A.

Preferably, the inclination with respect to the plane of rotation C and/or the conformation of the elongated body 2 varies gradually along the direction of development A.

Advantageously, the inclination of the elongated body 2 with respect to the plane of rotation C varies along the direction of development A with a degree of variation in inclination that depends on the length of the body 2.

In the remainder of the following disclosure, the term “degree of variation” referred to the inclination and/or to the conformation of the elongated body 2 is intended to indicate the variation per unit of length that these characteristics undergo along the direction of development A.

Preferably, the degree of variation in inclination is inversely proportional to the length of the elongated body 2.

In other words, the greater the length of the elongated body 2, the smaller the degree of variation in inclination.

Similarly, the conformation of the elongated body 2 varies along the direction of development A with a degree of variation in conformation which depends on the length of the elongated body 2.

Preferably, the degree of variation in conformation is inversely proportional to the length of the elongated body 2.

In other words, the greater the length of the elongated body 2, the smaller the degree of variation in conformation.

Conveniently, the cross section 6 is substantially inclined with respect to the plane of rotation C.

In particular, the cross section 6 is substantially inclined with respect to the plane of rotation C by a stagger angle substantially decreasing along the direction of development A.

Preferably, the stagger angle decreases along the direction of development A from the first end 3 to the second end 4.

Conveniently, the cross section 6 has a substantially curved conformation.

In particular, the cross section 6 has a radius of curvature substantially increasing along the direction of development A.

Advantageously, the radius of curvature increases along the direction of development A from the first end 3 to the second end 4.

In addition, the cross section 6 has a substantially decreasing chord along the direction of development A.

Preferably, the chord decreases along the direction of development A from the first end 3 to the second end 4.

These solutions make it possible to vary the inclination and/or the conformation of each point of the elongated body 2 along the direction of development A depending on the distance of such a point from the first end 3.

At least one of either the inclination or the conformation of the cross section 6 varies along the direction of development A, in such a way as to keep substantially constant the flow rate of the air flow moved by the elongated body 2 along the same direction of development A.

These solutions increase the flow rate of the air flow moved by the blade 1, the total dimensions of the blades of known type being equal.

Appropriately, the blade 1 comprises at least one protruding portion 7 associated with the second end 4 and lying on a lying plane D substantially transverse to the plane of rotation C.

Preferably, the protruding portion 7 is made in a single body piece with the elongated body 2.

In particular, the protruding portion 7 increases the distance travelled by the air flow moved by the blade 1.

Conveniently, the blade 1 is made of carbon.

This solution significantly reduces the weight of the blade 1 compared to the blades of known type without reducing the strength thereof.

One object of the present invention is a fan 8 comprising:
at least one blade 1;
the central body 5 rotating around the axis of rotation B.

Advantageously, the first end 3 is locked together in rotation to the central body 5.

Preferably, the central body 5 extends along the axis of rotation B for a predefined length of development.

The cross section 6 of the elongated body 2 at the first end 3 extends along the axis of rotation B for a length substantially less than or equal to the predefined length of development.

Advantageously, the fan 8 comprises interlocking coupling means 9, 10 of the blade 1 to the central body 5.

Conveniently, the coupling means 9, 10 comprise at least one recess 9, made on one of either the central body 5 or the blade 1, and at least one interlocking portion 10, made on the other of either the central body 5 or the blade 1 and coupled by interlocking inside the recess 9.

Preferably, the recess 9 is made on the central body 5 and the interlocking portion 10 is made on the blade 1.

Furthermore, the recess 9 and the interlocking portion 10 are made of complementary conformation to each other, thus facilitating the interlocking coupling thereof.

Further embodiments of the fan 8 cannot however be ruled out wherein the central body 5 and the blade 1 are made in a single body piece.

Preferably, the central body 5 is made of carbon.

Conveniently, the fan 8 comprises a plurality of blades 1 arranged in a radial pattern around the axis of rotation B.

Usefully, the fan 8 comprises three blades 1 spaced apart from each other by an opening angle of 120°.

Further embodiments of the fan 8 cannot however be ruled out wherein the fan 8 comprises a different number of blades 1 spaced apart from each other by a different opening angle, for example five blades 1 spaced apart by an opening angle of 72°.

Preferably, the fan 8 is of the type of a ceiling fan.

Appropriately, the fan 8 comprises at least one supporting body 11 associated with a ceiling 12 of a room.

The central body 5 is mounted on the supporting body 11 movable in rotation with the axis of rotation B arranged substantially transverse to the ceiling 12.

Preferably, the central body 5 is mounted on the supporting body 11 with the axis of rotation B orthogonal to the ceiling 12.

The fan 8 comprises motor-driven means, not shown in the figures, positioned between the supporting body 11 and the central body 5 and adapted to rotate the latter around the axis of rotation B.

It has in practice been ascertained that the described invention achieves the intended objects.

In particular, the fact is underlined that the variation of at least one of either the inclination or the conformation of the elongated body along the direction of development thereof allows varying the flow rate of the air moved by the blade. In particular, this device allows making constant the flow rate of the air flow moved by the blade along the direction of extension and increasing the flow rate itself, the total dimensions of the blades of known type being equal.

Moreover, the protruding portion allows increasing the distance travelled by the air flow moved by the blade, the total dimensions of the blades of known type being equal.

Also, the carbon blade allows for a considerable reduction in weight without reducing strength compared to the blades of known type.

In addition, the coupling means allow the blade to be interlocked with the central body quickly, easily and safely.

1) A blade for room fans, the blade comprising:
an elongated body extending longitudinally along a longitudinal direction of development and provided with a first end mounted, in use, on a central body movable in rotation around an axis of rotation orthogonal to said direction of development for the movement of at least one air flow intended for the airing/ventilation of rooms, and a second end opposite said first end, said elongated body rotating arranged on a plane of rotation orthogonal to said axis of rotation; wherein
said elongated body is provided with a cross section the inclination of which with respect to said plane of rotation and/or the conformation of which varies along said direction of development.

2) The blade according to claim 1, wherein said cross section is substantially inclined with respect to said plane of rotation.

3) The blade according to one claim 1, wherein said cross section is substantially inclined with respect to said plane of rotation by a stagger angle substantially decreasing along said direction of development.

4) The blade according to claim 1, wherein said cross section has a substantially curved conformation.

5) The blade according to claim 1, wherein said cross section has a radius of curvature substantially increasing along said direction of development.

6) The blade according to claim 1, wherein said cross section has a substantially decreasing chord along said direction of development.

7) The blade according to claim 1, further comprising: at least one protruding portion associated with said second end and lying on a lying plane substantially transverse to said plane of rotation.

8) The blade according to claim 1, wherein said blade is made of carbon.

9) A fan comprising:
at least one blade including said blade according to claim 1; and
said central body rotating around said axis of rotation;
wherein said first end is locked together in rotation to said central body.

10) The fan according to claim 9, further comprising: interlocking coupling means of said blade to said central body.

11) The tan according to claim 9, further comprising: a plurality of said blades arranged in a radial pattern around said axis of rotation.
